(19) United States
(12) Patent Application Publication
(10) Pub. No.: US 2026/0219469 A1
(43) Pub. Date: Jul. 30, 2026

(54) OPTICAL FIBER STRUCTURE FOR ROAD SURFACE LAYING AND LAYING METHOD THEREOF

(71) Applicant: NTT, Inc., Tokyo (JP)

(72) Inventors: Yasuhiro MAEHARA, Musashino-shi, Tokyo (JP); Sadaharu HOMAN, Musashino-shi, Tokyo (JP); Yusuke Yamada, Musashino-shi, Tokyo (JP); Takayoshi MORI, Musashino-shi, Tokyo (JP); Takashi MATSUO, Musashino-shi, Tokyo (JP); Masashi KIKUCHI, Musashino-shi, Tokyo (JP); Shun KOBAYASHI, Musashino-shi, Tokyo (JP); Akira Sakurai, Musashino-shi, Tokyo (JP)

(21) Appl. No.: 19/146,094

(22) PCT Filed: Jan. 19, 2023
(86) PCT No.: PCT/JP2023/001516

§ 371 Date: Jul. 7, 2025

(51) Int. Cl. G02B 6/46; G02B 6/44

(52) U.S. Cl. CPC G02B 6/46; G02B 6/4431

(57) ABSTRACT

An optical fiber structure for being laid on a road surface includes: a protection member extending in a longitudinal direction and having a bottom surface, a top surface having a predetermined height from the bottom surface, and a cavity formed in the longitudinal direction between the bottom surface and the top surface; an adhesive layer formed on the bottom surface with an adhesive; and an optical fiber stored in the cavity. The cavity has an opening in the top surface, and the optical fiber 13 stored in the cavity can be taken out through the opening.

### TECHNICAL FIELD

The present disclosure relates to an optical fiber structure for being laid on a road surface and a method for laying the same.

### BACKGROUND ART

An optical fiber cable that connects a user and a device of a housing station to provide a service to the user is installed on the ground or utility poles. Many optical fiber cables installed on the ground are laid by being buried in the ground. In order to bury and lay an optical fiber cable in the ground, it is necessary to perform processes of excavating the ground deeply, installing the optical fiber cable in the dug groove, and burying soil back into the groove after installing the optical fiber cable. Patent Literature 1 discloses a technique of burying and laying an optical fiber cable in the ground.

### CITATION LIST

### Patent Literature

Patent Literature 1: JP 6374435 B2

### SUMMARY OF INVENTION

### Technical Problem

However, in order to bury and lay an optical fiber cable in the ground, much of the work is spent on a process of digging a groove in the ground and a process of burying the groove back after installing the optical fiber cable in the groove, which impose a heavy burden of the work and increase the cost for laying the optical fiber cable.

The present disclosure is proposed in view of the above circumstances, and an object of the present disclosure is to provide an optical fiber structure for being laid on a road surface and a method for laying the same, which can reduce the burden of work of laying an optical fiber cable on the ground and reduce the cost.

### Solution to Problem

In order to solve the above-described problems, an optical fiber structure for being laid on a road surface according to the present disclosure includes: a protection member extending in a longitudinal direction and having a bottom surface, a top surface having a predetermined height from the bottom surface, and a cavity formed in the longitudinal direction between the bottom surface and the top surface; an adhesive layer formed on the bottom surface with an adhesive; and an optical fiber stored in the cavity.

A method for laying an optical fiber structure for being laid on a road surface includes fixing a bottom surface of an optical fiber structure for being laid on a road surface to a road surface with an adhesive layer, the optical fiber structure including: a protection member extending in a longitudinal direction and having a bottom surface, a top surface having a predetermined height from the bottom surface, and a cavity formed in the longitudinal direction between the bottom surface and the top surface; the adhesive layer formed on the bottom surface of the protection member with an adhesive; and an optical fiber stored in the cavity.

### Advantageous Effects of Invention

According to the present disclosure, it is possible to reduce the burden of work of laying an optical fiber cable on the ground and to reduce the cost.

### BRIEF DESCRIPTION OF DRAWINGS

FIG. 1 is an overhead view of an optical fiber structure for being laid on a road surface.

FIG. 2 is a cross-sectional view of the optical fiber structure for being laid on a road surface.

FIG. 3 is a cross-sectional view illustrating the optical fiber structure for being laid on a road surface, which has been installed on a road surface.

FIG. 4 is an overhead view of an optical fiber structure for being laid on a road surface according to a modification.

FIG. 5 is a cross-sectional view illustrating a main part in the vicinity of tearing cords in the optical fiber structure for being laid on a road surface according to the modification.

### DESCRIPTION OF EMBODIMENTS

Hereinafter, an embodiment of an optical fiber structure for being laid on a road surface and a method for laying the same will be described in detail with reference to the drawings. A road surface in the present embodiment is assumed to be an outdoor paved ground such as a road, but is not limited thereto, and may be an unpaved outdoor ground, or may be an indoor floor surface without being limited to the outdoor grounds.

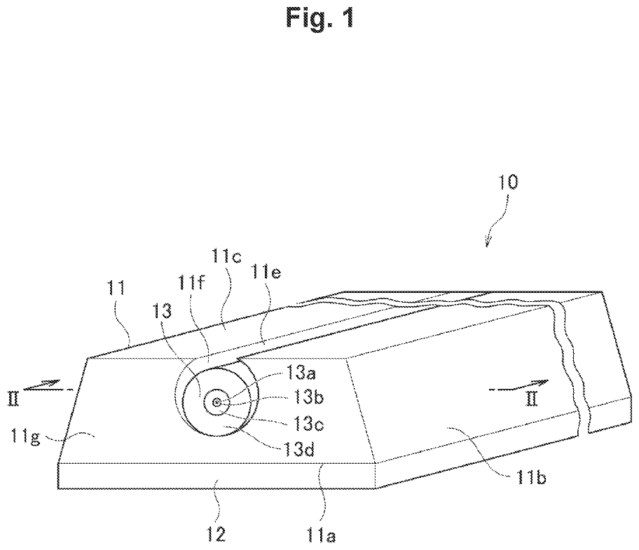

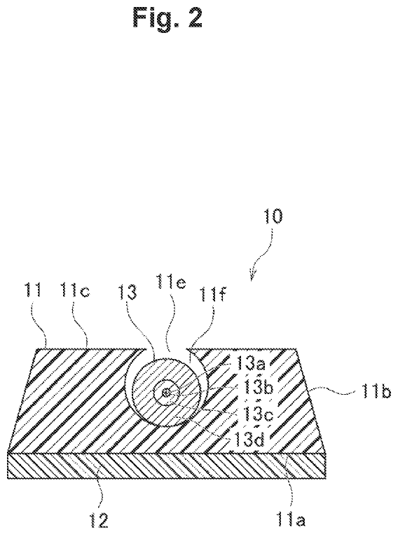

FIG. 1 is an overhead view of an optical fiber structure 10 for being laid on a road surface. FIG. 2 is a cross-sectional view of the optical fiber structure 10 for being laid on a road surface. The cross-sectional view of FIG. 2 illustrates a cross section II-II orthogonal to the longitudinal direction in which the optical fiber structure 10 for being laid on a road surface extends in the overhead view of FIG. 1.

The optical fiber structure 10 for being laid on a road surface includes a protection member 11, an adhesive layer 12 including an adhesive and formed on a bottom surface 11a of the protection member 11, and an optical fiber 13 stored in a cavity 11f formed in the protection member 11. The protection member 11 extends in the longitudinal direction and has the bottom surface 11a, a top surface 11c having a predetermined height from the bottom surface, and a side surface 11b formed between the bottom surface 11a and the top surface 11c. On the front side of FIG. 1, an end surface 11g of the optical fiber structure 10 for being laid on a road surface is illustrated. As illustrated in FIG. 2, the outer shape of a cross section of the protection member 11 forms an isosceles trapezoid in which the bottom surface 11a is a lower base, the top surface 11c is an upper base, the side surface 11b is an oblique side, and the lower base is longer than the upper base. Note that the outer shape of the cross section of the protection member 11 is not limited to an isosceles trapezoid.

In the protection member 11, the cavity 11f extending in the longitudinal direction and having a predetermined diameter is formed between the bottom surface 11a and the top surface 11c. The cavity 11f has an opening 11e in the top surface 11c. As illustrated in FIG. 2, in the cross section orthogonal to the longitudinal direction of the optical fiber structure 10 for being laid on a road surface, the cavity 11f may be located immediately below the central portion of the top surface 11c, and the opening 11e may be formed at the central portion of the top surface 11c.

On the bottom surface 11a of the protection member 11, the adhesive layer 12 including an adhesive and having a predetermined thickness is formed. The adhesive layer 12 may be formed by an adhesive being applied, or may be formed by a film of an adhesive being attached.

The optical fiber 13 is stored in the cavity 11f of the protection member 11. The optical fiber 13 extends in the cavity 11f in the longitudinal direction and includes, for example, a core 13a, cladding 13b, a primary coating 13c, and a secondary coating 13d. The illustrated optical fiber 13 is only stored in the cavity 11f and is not fixed to the cavity 11f. The optical fiber 13 has only the single core 13a, but may have a plurality of cores. In addition, the coating of the core 13a and the cladding 13b is not limited to two layers such as the primary coating 13c and the secondary coating 13d, and may be only one layer or three or more layers.

The protection member 11 is made of a resin such as polyvinyl chloride or high-density polyethylene so as to be able to protect the optical fiber 13 stored in the cavity 11f against contact or stepping by a person, a vehicle, or the like when installed on a road surface. The protection member 11 is not limited to a resin, and may be made of metal such as iron or SUS.

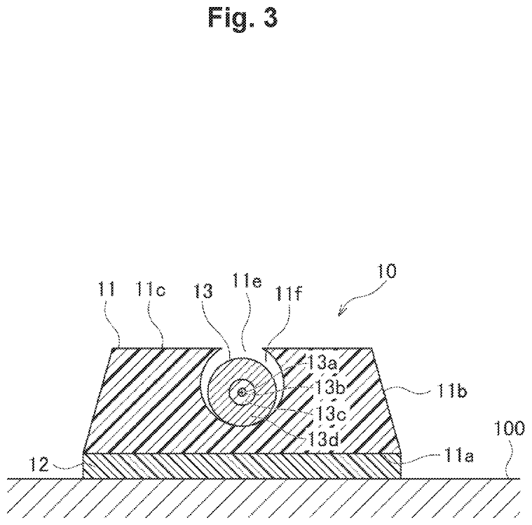

FIG. 3 is a cross-sectional view illustrating a state in which the optical fiber structure 10 for being laid on a road surface is laid on a road surface. The optical fiber structure 10 for being laid on a road surface can be laid by the adhesive layer 12 being bonded to a road surface 100 and the bottom surface 11a of the protection member 11 being fixed to the road surface 100. In a state where the optical fiber structure 10 for being laid on a road surface is laid on the road surface 100, the optical fiber 13 stored in the cavity 11f of the protection member 11 can be taken out of the protection member 11 through the opening 11e.

According to the present embodiment, in order to lay the optical fiber on the road surface 100, it is sufficient only to bond the adhesive layer 12 of the optical fiber structure 10 for being laid on a road surface to the road surface 100 and fix the protection member 11 to the road surface 100, so that the burden of the laying work can be reduced. In addition, since man-hours for laying are not required, the cost can also be reduced. In the optical fiber structure 10 for being laid on a road surface, the optical fiber 13 is stored in the cavity 11f inside the protection member 11, and thus, even if a person, a vehicle, or the like touches or steps on the optical fiber structure 10 for being laid on a road surface, the optical fiber 13 is not bent or twisted.

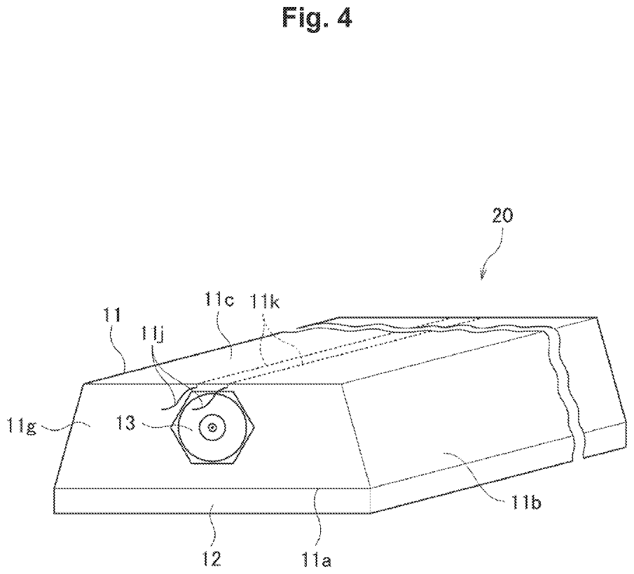

FIG. 4 is an overhead view of an optical fiber structure for being laid on a road surface according to a modification. An optical fiber structure 20 for being laid on a road surface according to the modification is different from the optical fiber structure 10 for being laid on a road surface according to the present embodiment illustrated in FIGS. 1 and 2 in that, instead of opening of the cavity 11f in the top surface 11c, tearing cords 11j for tearing the protection member 11 to form an opening are embedded in a portion between the top surface 11c and the cavity 11f of the protection member 11.

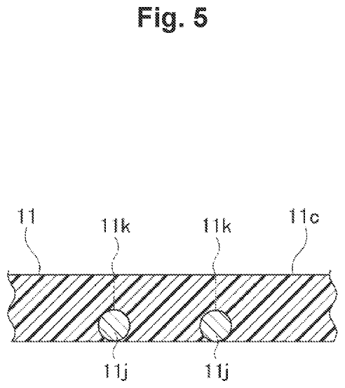

Specifically, the outline of a cross section of the cavity 11f of the optical fiber structure 20 for being laid on a road surface according to the modification is a regular hexagon having at least a predetermined diameter, and one pair facing each other in the plane forming the cavity 11f is parallel to the bottom surface 11a and the top surface 11c. Referring to the cross-sectional view of FIG. 5 illustrating a main part in the vicinity of the tearing cords 11j, the pair of tearing cords 11j extending in the longitudinal direction at a predetermined depth from the top surface 11c is embedded at a predetermined interval in a portion between the top surface 11c and the cavity 11f of the protection member 11. In addition, perforations 11k are formed from the top surface 11c toward the tearing cords 11j. The structure of the modification other than this is similar to that of the optical fiber structure 10 for being laid on a road surface according to the present embodiment, and common reference numerals are given to corresponding constituent members to clarify a correspondence relationship.

Also in the modification, the method for laying the optical fiber structure 20 for being laid on a road surface on a road surface is similar to the method for laying the optical fiber structure 10 for being laid on a road surface according to the present embodiment illustrated in FIG. 3. That is, the adhesive layer 12 of the optical fiber structure 20 for being laid on a road surface according to the modification is bonded to the road surface 100, and the bottom surface 11a of the protection member 11 is fixed to the road surface 100.

In the modification, in order to take out the optical fiber from the optical fiber structure 20 for being laid on a road surface, the protection member 11 is removed by being scraped up to the tearing cords 11j along the perforations 11k formed from the top surface 11c of the protection member 11 toward the tearing cords 11j. When the protection member 11 is removed up to the tearing cords 11j, the tearing cords 11j are pulled to tear the protection member 11, and an opening of the cavity 11f is formed in the top surface 11c. In the modification, the protection member 11 is made of a resin such as polyvinyl chloride or high-density polyethylene so that the protection member 11 can be removed from the top surface 11c to the tearing cords 11j and torn by the tearing cords 11j. Through the opening 11e formed in this manner, the optical fiber 13 stored in the cavity 11f of the protection member 11 can be taken out of the cavity 11f.

Also in the modification, similarly to the present embodiment, in order to lay the optical fiber on the road surface, it is sufficient only to bond the adhesive layer 12 of the optical fiber structure 20 for being laid on a road surface according to the modification to the road surface 100 and fix the protection member 11 to the road surface 100, so that the burden of the laying work can be reduced. In addition, since man-hours for laying are not required, the cost can also be reduced.

Also in the optical fiber structure 20 for being laid on a road surface according to the modification, the optical fiber 13 is stored in the cavity 11f inside the protection member 11, and thus, even if a person, a vehicle, or the like touches or steps on the optical fiber structure 20 for being laid on a road surface, the optical fiber 13 is not bent or twisted. In addition, in the modification, the optical fiber is formed in the closed cavity 11f having no opening formed in the protection member 11, and thus, even if the optical fiber is installed on an outdoor road surface, the optical fiber is not affected by inflow of earth and sand, rainwater, or the like into the cavity.

### REFERENCE SIGNS LIST

10 Optical fiber structure for being laid on road surface
11 Protection member
11a Bottom surface
11c Top surface
11e Opening
11f Cavity
12 Adhesive layer
13 Optical fiber

1. An optical fiber structure configured to be laid on a road surface, the optical fiber structure comprising:
a protection member extending in a longitudinal direction and having a bottom surface, a top surface having a predetermined height from the bottom surface, and a cavity formed in the longitudinal direction between the bottom surface and the top surface;
an adhesive layer formed on the bottom surface with an adhesive; and
an optical fiber stored in the cavity.

2. The optical fiber structure configured to be laid on a road surface according to claim 1, wherein the cavity has an opening to the top surface.

3. The optical fiber structure configured to be laid on a road surface according to claim 1, wherein the protection member includes a tearing cord embedded between the cavity and the top surface and configured to allow a portion of the protection member between the cavity and the top surface to be torn and the cavity to be opened to the top surface.

4. The optical fiber structure configured to be laid on a road surface according to claim 3, wherein the protection member has perforations from the top surface toward the tearing cord.

5. A method for laying an optical fiber on a road surface, the method comprising fixing an optical fiber structure to a road surface with an adhesive layer, the optical fiber structure including: a protection member extending in a longitudinal direction, the protection member having a bottom surface, a top surface having a predetermined height from the bottom surface, and a cavity formed in the longitudinal direction between the bottom surface and the top surface; the adhesive layer on the bottom surface of the protection member with an adhesive; and an optical fiber stored in the cavity.

6. The method for laying an optical fiber on a road surface according to claim 5, wherein the cavity has an opening in the top surface, and the protection member is configured so that the optical fiber can be taken out from the cavity opening.

7. The method for laying an optical fiber on a road surface according to claim 5, wherein
the protection member includes a tearing cord embedded in a portion of the protection member between the top surface and the cavity,
the protection member is configured to be torn with the tearing cord to allow the cavity to open to the top surface, and
the optical fiber is configured to be taken out from the cavity opening-cavity.

8. The method for laying an optical fiber on a road surface according to claim 7, wherein the protection member has perforations from the top surface toward the tearing cord, and the protection member is configured to be removed to a depth of the tearing cord along the perforations.
